(19) United States
(12) Patent Application Publication
(10) Pub. No.: US 2022/0224961 A1
(43) Pub. Date: Jul. 14, 2022

(54) Method of display and operation when a smartphone and a terminal are connected

(71) Applicant: Yen-Ho Lu, Taichung (TW)

(72) Inventor: Yen-Ho Lu, Taichung (TW)

(21) Appl. No.: 17/144,152

(22) Filed: Jan. 8, 2021

(51) Int. Cl. H04N 21/41; H04N 21/422; H04N 21/485; G06F 3/0488; G06F 3/0481

(52) U.S. Cl. CPC H04N 21/4126; H04N 21/42224; H04N 21/485; G06F 2203/04803; G06F 3/04812; G06F 2203/04806; G06F 3/04886

(57) ABSTRACT

The invention provides a method of display and operation when a smartphone and a terminal are connected, aiming to enhance a user's experiences, which include showing a cursor whose position mirrors touch location on the smartphone screen on the terminal screen, displaying a zoomed-in view of a partial area of the smartphone screen when the smartphone is in vertical display mode, and turning the physical buttons on the smartphone into new functions.

### BACKGROUND OF THE INVENTION

As technology develops, nowadays a smartphone can conveniently connect to a TV (a type of terminal) with wifi, allowing mirroring the smartphone on the TV screen. When the smartphone is in vertical display mode, however, the mirroring view is usually displayed very small on TV screen, which makes users unable to enjoy an enlarged view as the connection and mirroring are meant for. Also, another drawback of the prior art is that it is hard to eyeball on TV screen and finger-operate smartphone at the same time because there is no cursor on TV to show where the controlling finger is actually at on the smartphone screen.

### SUMMARY OF THE INVENTION

This invention provides a method of display and operation when a smartphone and a terminal are connected, aiming to enhance a user's experiences as stated as below. After the connection is established between a smartphone and a terminal, the control system in the connection among the smartphone, the terminal and their connecting equipment (if any) can command that (1) a cursor shows up on the terminal screen, and its position on the mirroring smartphone view on the terminal screen approximately mirrors the touch location of the controlling finger on the smartphone screen, so that a user can simply finger-operate the smartphone by looking at the terminal screen instead of the smartphone screen for greater comfort; (2) the terminal screen displays zoomed-in view of a partial area of the smartphone screen for an enlarged view and enhanced comfort when the smartphone is in vertical display mode; and (3) the physical buttons on the smartphone turn into new functions, such as for bullet-shooting for video games of the smartphone, that are different from their original functions for the smartphone, so for better operational conveniences. With aforementioned method, we believe the invention can greatly enhance a user's experiences. To further clear, above connection can mean the connection among a plurality of smartphones and terminals.

### BRIEF DESCRIPTION OF THE DRAWINGS

FIG. 1: A flow chart that describe how the control system moves the cursor.

FIG. 2: The terminal screen shows split displays for both whole view and zoomed-in view for a partial area of the smartphone screen when the smartphone is in vertical display mode.

### DETAILED DESCRIPTION OF THE INVENTION

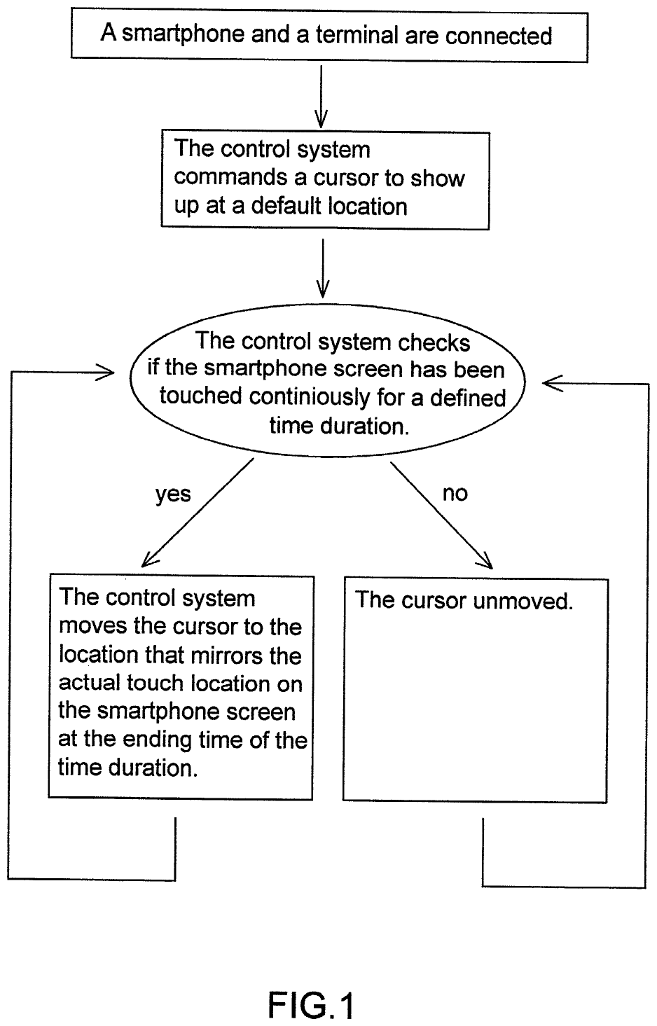

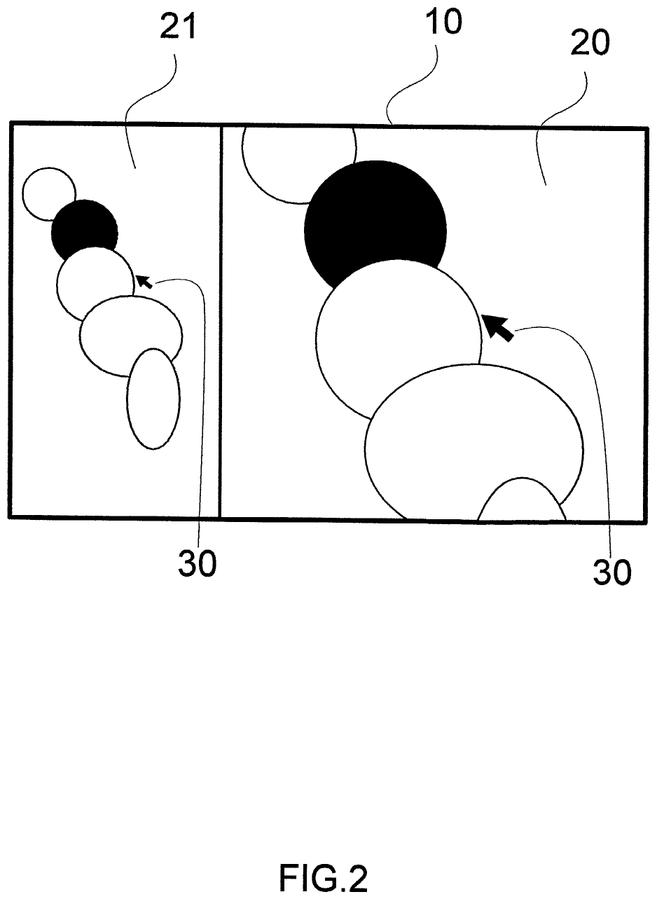

Referring to FIGS. 1 and 2 for preferred example, the invention proposes a method of display and operation when a smartphone and a terminal are connected as stated as below. After the connection is established between a smartphone and a terminal, the control system in the connection can command that (1) a cursor 30 shows up on the terminal screen 10 at a default location at first. Afterward, when the control system detects that the smartphone has been touched for a defined duration of time, it commands to move the cursor 30 to the position that mirrors the touch location of the controlling finger on the smartphone screen at the ending time of the time duration. With continuous detection of the control system, the movements of the cursor 30 can be depicted; (2) the terminal screen 10 shows split displays for both whole view 21 and zoomed-in view 20 for a partial area of the smartphone screen when the smartphone is in vertical display mode. The zoomed-in view 20 dynamically shows the neighboring area that surrounds the cursor 30, and thus the cursor 30 will always show up in the zoomed-in view 20; and (3) the physical buttons on the smartphone can turn into new functions that are different from their original functions.

1. A method of display and operation when a smartphone and a terminal are connected, wherein the terminal shows split displays for both a whole view and zoomed-in view for a partial area of the smartphone screen when the smartphone is in vertical display mode.
